(19) United States
(12) Patent Application Publication
(10) Pub. No.: US 2002/0016874 A1
(43) Pub. Date: Feb. 7, 2002

(54) Circuit multiplexing method and information relaying apparatus

(76) Inventors: Tatsuya Watanuki, Ebina (JP); Toshikazu Yasue, Chigasaki (JP); Kazuko Iwatsuki, Kawasaki (JP); Takahisa Miyamoto, Ebina (JP)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/904,130

(22) Filed: Jul. 11, 2001

(30) Foreign Application Priority Data
Jul. 11, 2000 (JP) 2000-209447

(51) Int. Cl. G06F 3/00

(52) U.S. Cl. 710/51

(57) ABSTRACT

An information network 200 extends between a first information relaying apparatus 20 and a terminal 23, which are equipped with existing circuit multiplexing modules 39. Signals from the information relaying apparatus 20 pass through additional information relaying apparatuses 21, 22, which relay signals output from the information relaying apparatus 20. The information relaying apparatuses 21, 22 associate LAN lines between the information relaying apparatus 20 and the terminal 23 into separate groups and effectively monitor these LAN lines. If a failure is detected, then all LAN lines belonging to the group of the LAN line experiencing the failure are effectively shut down. As a result, circuit multiplexers 39 in the information relaying apparatus 20 are then instructed to use a different LAN line that is not experiencing failure so that communication can continue.

### CROSS-REFERENCES TO RELATED APPLICATIONS

This application is related to and claims priority from Japanese Patent Application No. 2000-209447, filed on Jul. 11, 2000.

### BACKGROUND OF THE INVENTION

The present invention relates to a circuit multiplexing method and an information relaying apparatus. More specifically, the present invention relates to a circuit multiplexing method and an information relaying apparatus that multiplexes circuits to improve the usability of a system formed with multiple network devices, e.g., LAN switches, and terminals, e.g., servers.

Circuit multiplexing technology is in widespread use to connect network devices such as two LAN (Local Area Network) switches and to connect network devices and terminals, e.g., servers. By allowing multiple physical circuit connections, usability is improved. An example of circuit multiplexing technology is the Link Aggregation method described in the draft 802.3ad from the Institute of Electrical and Electronics Engineers (most recent draft as of November 1999 is IEEE 802.3ad/D2.0).

In this Link Aggregation method, for example, two LAN switches are connected by multiple LAN lines (e.g., Ethernet), and load balancing is performed for packets sent over these LAN switches destined for different LAN lines using an algorithm such as a round-robin algorithm. If a failure such as a line break takes place in one of the multiplexed LAN lines, the LAN switches redirect packets that were intended to be sent through the failed LAN line to the remaining LAN lines so that communication can be continued. As a result, the usability of the communication lines between the two LAN switches can be improved. In this manner, a highly usable network can be formed through Link Aggregation between network devices or between network devices and terminals.

However, Link Aggregation is a method that can be used only for one-to-one connections, i.e., between two devices. Thus, circuit redundancy can only be provided between two devices. Thus, using Link Aggregation to improve the overall usability of a system formed by multiple network devices and terminals is difficult.

An extension of Link Aggregation known as MPLA (MultiPoint Link Aggregation) is available. In MPLA, Link Aggregation is implemented for one-to-many connections, i.e., between one device and multiple devices. By forming a network system using multiple LAN switches and multiple servers and the like equipped with MPLA allows the overall usability of the system to be improved.

However, to improve overall usability in a system formed from multiple network devices and terminals using MPLA requires that all the devices in the system be equipped with MPLA. Furthermore, in recent years, multi-vendor environments have become standard system environments. The need to equip all devices with MPLA appears to be a major restriction in designing a highly usable network system with circuit multiplexing technology.

It is desirable to improve overall usability of a network system without modifying devices that are equipped with existing circuit multiplexing technologies.

### SUMMARY OF THE INVENTION

A data relay apparatus and method in accordance with the invention includes receiving data from one or more first data ports and transmitting the data via one or more second data ports. Conversely, data received from the second data ports is transmitted over the first data ports. Upon detecting that communication is not possible via any of the first data ports, due for example by downed communication lines coupled to the first data ports, the first and second data ports are disabled. Upon detecting that communication is not possible via any of the second data ports, the first and second data ports are disabled.

In another aspect of the invention, a plurality of data relay apparatuses are configured in a cross-coupled arrangement. Such an arrangement is used to provide multiple data paths and is used in multi-level switching environments.

### BRIEF DESCRIPTION OF THE DRAWINGS

FIG. 1 is a drawing showing the schematic architecture of an information network 200 that uses information relaying apparatuses 21, 22 according to a first embodiment of the present invention;

FIG. 2 is a drawing showing the structure of a port management table 40;

FIG. 3 is a drawing showing the structure of an information relay table 50;

FIG. 4 is a drawing showing the structure of an address table 60;

FIG. 5 is a drawing showing the structure of a port management table 40 when a LAN line failure takes place;

FIG. 6 is a flowchart of a circuit multiplexer support process 70;

FIG. 7 is a schematic drawing of the architecture of an information network 201 that uses information relaying apparatuses 21, 22 according to a second embodiment of the present invention;

FIG. 8 is a drawing showing the structure of a port management table 80;

FIG. 9 is a drawing showing the structure of an information relay table 90;

FIG. 10 is a drawing showing the structure of an address table 100;

FIG. 11 is a drawing showing the structure of a port management table 80 when a LAN line failure has taken place;

FIG. 12 is a flowchart of a circuit multiplexer support process 110;

FIG. 13 is a drawing showing the structure of a port management table 80 when LAN line (1 and 2) failures take place;

FIG. 14 is a drawing showing the schematic architecture of an information network 202 that uses information relaying apparatuses 122, 123 according to a third embodiment of the present invention;

FIG. 15 is a drawing showing the schematic architecture of an information network 203 that uses information relaying apparatuses 122, 123 according to a fourth embodiment of the present invention;

FIG. 16 is a drawing showing the structure of a port management table 40 of an information relaying apparatus 122;

FIG. 17 is a drawing showing the schematic architecture of an information network 204 that uses information relaying apparatuses 122, 123 according to a fifth embodiment of the present invention; and

FIG. 18 is a drawing showing the structure of a port management table 80 of an information relaying apparatus 122.

### DESCRIPTION OF THE SPECIFIC EMBODIMENTS

Below is an overview of example embodiments illustrating the present invention. The overview is followed by specific descriptions of illustrative examples presented.

The present invention provides a circuit multiplexing means in an information network that sends and receives signals via an information relaying apparatus between devices equipped with circuit multiplexing modules. The information relaying apparatus associates preferred circuits out of circuits forming signal paths with different circuit groups and monitors circuits belonging to the circuit groups for failure. If a failure is detected in any of the circuits, the information relaying apparatus shuts down all circuits belonging to a circuit group of the failed circuit.

The present invention provides an information relaying apparatus disposed between devices via a circuit and sending and receiving signals between the devices. The information relaying apparatus includes: means for storing a plurality of circuits as belonging to a single circuit group; means for monitoring failures in each of the circuits; means for monitoring circuit recovery after a circuit failure takes place; means for shutting down all circuits belonging to the same circuit group as a circuit in which a failure was detected out of circuit groups stored in circuit storing means if failure monitoring means detects a circuit failure.

The present invention, for example, can be a circuit multiplexing method for an information network in which at least two paths are formed between at least two devices equipped with existing circuit multiplexing methods for multiplexing circuits. The paths extend by way of at least two information relaying apparatuses, which are connected to at least two circuits.

The information relaying apparatus can associate multiple circuits in a path with a single circuit group, and circuit failures can be monitored using ICMP (Internet Control Message Protocol) messages, ARP (Address Resolution Protocol) messages, or control messages from existing circuit multiplexing methods. If a failure is detected in a circuit, all circuits belonging to the same circuit group as the circuit can be shut down.

Also, after a circuit failure is detected, the information relaying apparatus of the present invention can monitor recovery of the circuit. When recovery is detected, all circuits belonging to the same circuit group as the circuit can be made usable. Further, the present invention, for example, can be a circuit multiplexing method for an information network in which at least two paths are formed between at least two apparatuses equipped with existing circuit multiplexing methods for multiplexing circuits. The paths extend by way of at least two information relaying apparatuses, which are connected to at least two circuits.

The information relaying apparatus can periodically monitor circuit failures using ICMP messages, ARP messages, or control messages from existing circuit multiplexing methods. If a failure is detected, all circuits connected to the information relaying apparatus can be shut down.

Also, the information relaying apparatus of the present invention can, for example, monitor recovery of a circuit after a failure in the circuit is detected. When recovery is detected, all circuits connected to the information relaying apparatus can be made usable.

Also, the present invention can be an information relaying apparatus connecting at least two circuits and including: means for storing circuits storing a plurality of circuits as belonging to a single circuit group; means for monitoring failures in each of the circuits; means for monitoring circuit recovery after a circuit failure takes place; means for shutting down all circuits belonging to the same circuit group as a circuit in which a failure was detected out of circuit groups stored in circuit storing means if failure monitoring means detects a circuit failure; and means for making usable all circuits belonging to the same circuit group as a circuit in which recovery was detected out of circuit groups stored in circuit storing means if recovery monitoring means detects recovery of a circuit.

Also, the present invention can provide an information relaying apparatus connecting at least two circuits and including: means for monitoring failures in each of the circuits; means for monitoring circuit recovery after a circuit failure takes place; means for shutting down all circuits connected to the information relaying apparatus; and means for making usable all circuits connected to the information relaying apparatus if recovery monitoring means detects recovery of a circuit.

Also, the present invention can further include means for storing device addresses. Circuit failures and recoveries can be monitored using addresses stored in address storing means, and using ICMP messages or ARP messages.

In the present invention, failure monitoring means and recovery monitoring means can perform monitoring using control messages used in existing circuit multiplexing methods, e.g., LACP messages from the Link Aggregation method. Also, failure monitoring means and recovery monitoring means can monitor failures and recovery in divisions connected to circuits in the information relaying apparatus.

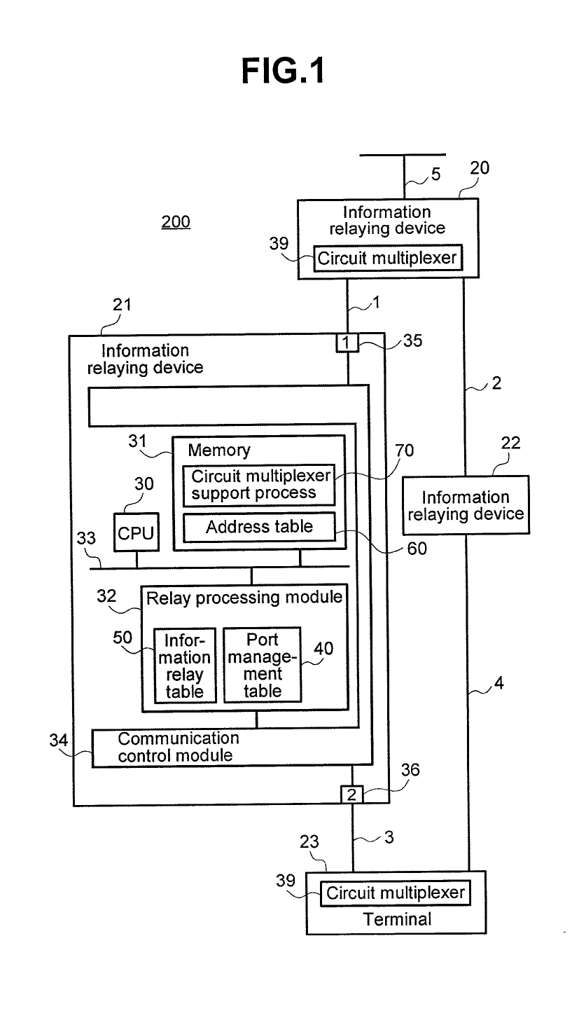

The various illustrative embodiments of the present invention will be described in detail using the drawings. In a first embodiment, FIG. 1 shows a schematic drawing showing the architecture of an information network 200 that uses information relaying apparatuses 21, 22.

The information network 200 can include, for example: an existing terminal 23 such as a server (i.e. a data source); an existing information relaying apparatus 20 such as a multi-layer switch that performs information relaying operations at the second layer (data link layer) and the third layer (network layer) of the OSI reference model; and the information relaying apparatuses 21, 22, e.g., two-layer switches performing information relaying operations at the data link layer where one switch can be viewed as being a data source to the other switch, disposed between the terminal 23 and the information relaying apparatus 20. The terminal 23, the information relaying apparatus 20, and the information relaying apparatuses 21, 22 can, for example, be connected respectively by a LAN line 1, a LAN line 2, a LAN line 3, and a LAN line 4 forming a bus-type LAN (Ethernet). The information relaying apparatus 20 is also connected to a LAN line 5. More specifically, the information network 200 serves as an example of a network structure that can be seen in corporations, data centers, or the like. In this case, the information relaying apparatus 20 is placed in a trunk line such as a backbone, and the information relaying apparatuses 21, 22 serve as server switches for servers.

In this embodiment, the terminal 23 and the information relaying apparatus 20 are equipped with circuit multiplexers 39 that implement an existing circuit multiplexing system such as link aggregation. Physically, the LAN between the terminal 23 and the information relaying apparatus 20 are connected by two LAN lines by way of the information relaying apparatuses 21, 22, but are treated logically as a single LAN line through the circuit multiplexers 39.

The architecture of the information relaying apparatus 21 according to this embodiment will be described. Since the information relaying apparatuses 21, 22 have identical architectures, the description of the information relaying apparatus 22 will be omitted. The information relaying apparatus 21 provides control for the first layer (physical layer) of the OSI reference model and includes: two physical ports (physical ports 35, 36) providing physical connections to LAN lines; a communication controller 34 controlling the data link layer; a relay processing module 32 processing packet relaying operations in the data link layer; a CPU (Central Processing Unit) 30 controlling the apparatus and executing a circuit multiplexer support process 70 described later; a memory 31 storing processes executed by the CPU and the like; and a bus 33 connecting these elements. The physical ports 35-38 is implemented through hardware such as connectors for connecting LAN cables and PHY (PHYsical)—LSI (Large Scale Integrated circuit) devices. The communication control module 34 is implemented through hardware such as a MAC (Medium Access Control)—LSI.

The relay processing module 32 includes: an information relay table 50 managing relay destination ports for packets; and a port management table 40 managing port status. The memory 31 is equipped with: the circuit multiplexer support process 70; and an address table 60. In this embodiment, the physical port 35 and the physical port 36 are connected respectively to the LAN line 1 and the LAN line 3.

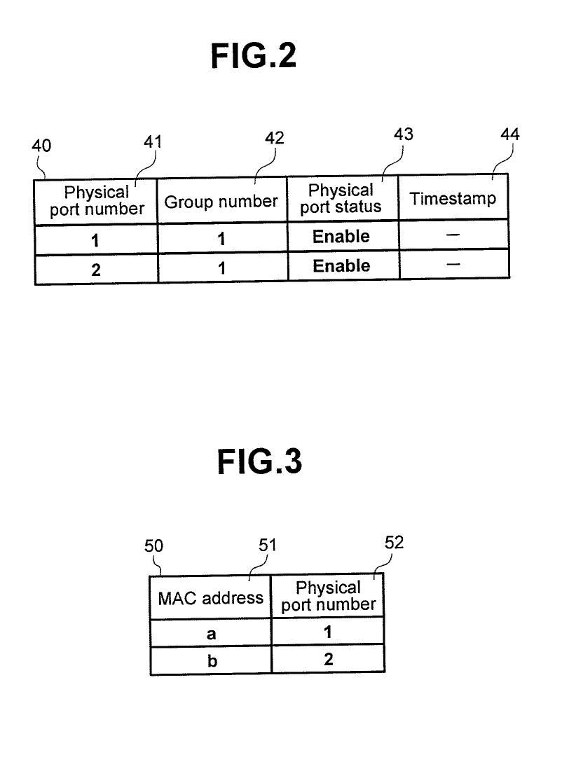

FIG. 2 shows the architecture of the port management table 40. The port management table 40 includes: a physical port number 41 indicating a physical port number; a physical port status 43 indicating the status of the port; a LAN line group number 42 for identifying the LAN lines between the information relaying apparatus 20 and the terminal 23 that the port is associated with; and a timestamp 44 for storing a timestamp in case a port failure takes place. The group number refers to the group of LAN lines which provide a data path between the terminal 23 and the information relaying apparatus 20.

This example shows the information relaying apparatus 21 when it is initialized, and the physical port 35 and the physical port 36 are set up with physical port numbers 1 and 2. The LAN line group number 42 is set to “1” to associate the ports with the LAN line 1 and the LAN line 3.

Similarly, in the information relaying apparatus 22, the LAN line 2 and the LAN line 4 are associated with the same LAN line group number 42 in a port management table 40 for that information relaying apparatus. The physical port status 43 is set to “Enable” if communication through the physical port is possible and “Disable” if communication is not possible. The physical port status 43 is set to “Enable” at initialization. The timestamp 44 is set up with no value at initialization.

FIG. 3 shows the architecture of the information relay table 50. The information relay table 50 contains: a MAC address 51 of a device such as the terminal 23 or the adjacent information relaying apparatus 20; and a physical port number 52 connecting the apparatus with the MAC address 51 to the LAN line. When a packet is received, this information relay table 50 stores the MAC address 51 contained in the header of the packet and the physical port number 52 from which the packet was received. This information relay table 50 is set with no values at initialization.

In this example, the MAC address 51 for the information relaying apparatus 20 and the terminal 23 are set to “a” and “b” respectively. The physical port number 52 fields are set to the physical port number “1” and the physical port number “2” for the physical port 35 and the physical port 36 connected to the LAN lines with the information relaying apparatus 20 and the terminal 23.

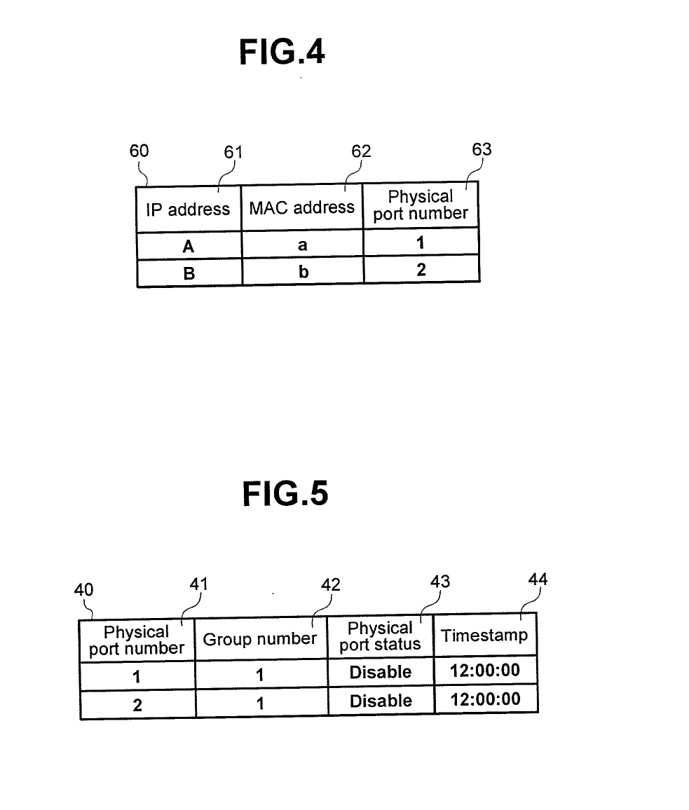

FIG. 4 shows the architecture of the address table 60. The address table 60 contains an IP (Internet Protocol) address 61 of the 23 or an adjacent information relaying apparatus 20; a MAC address 62; and a physical port number 63. This address table 60 is set up manually at initialization. The MAC address 61 and the physical port number 62 can be learned and stored through ARP (Address Resolution Protocol) or the like.

The IP address 61 fields are set to “A” and “B”, and the MAC address 62 fields are set to “a” and “b” for the information relaying apparatus 20 and the terminal 23 respectively. Furthermore, the physical port number 63 fields are set in this example to “1” and “2” for the physical port 35 and the physical port 36, which are connected to LAN lines with the information relaying apparatus 20 and the terminal 23.

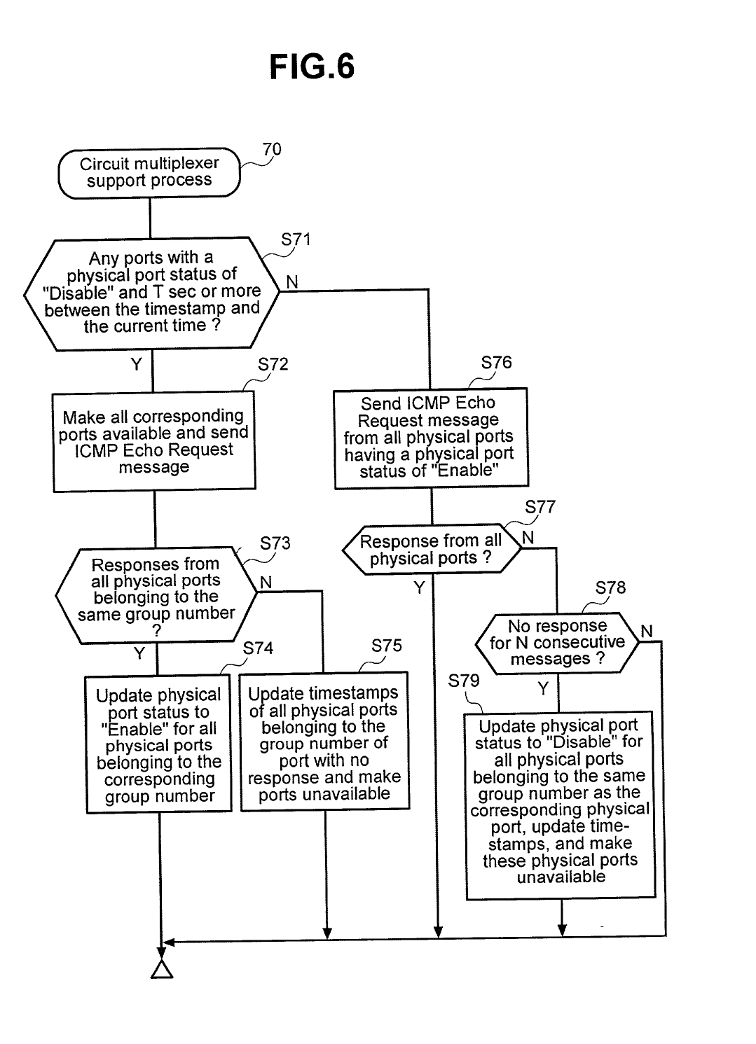

The following is an overview of the operations of this embodiment. FIG. 6 is a flowchart of the circuit multiplexer support process 70. First, the port management table 40 is looked up to see if there are any physical ports for which the physical port status 43 is “Disable” and at least T seconds have elapsed between the timestamp 44 and the current time (step S71). If there are any physical ports for which at least T seconds have elapsed, the LAN lines connected to these physical ports are electronically recovered to allow usage, the address table 60 is looked up, and an ICMP (Internet Control Management Protocol) Echo Request message is sent (step S72). Then, the process waits for responses to this message (step S73).

If a response (ICMP Echo Reply message) is received from all physical ports belonging to a single group number, it is assumed that a failure in a physical port belonging to the group number has been recovered. The physical status of these physical ports is set to “Enable” and the LAN line connected to the physical ports is electronically recovered to make it available for use (step S74). If there was no response from all the physical ports belonging to a single group, the timestamps for all the physical ports belonging to the group number are set to the current time. The LAN line connected to these physical ports is electronically cut off and shutdown, and the operation is exited (step S75).

If there are no applicable physical ports at step S71, ICMP Echo Request messages are sent from all physical ports with physical status set to “Enable” (step S76). Next, the responses to these messages are monitored (step S77).

If a response (ICMP Echo Reply message) is received from all physical ports, it is assumed that there are no failures and the operation is exited. If there is a physical port that did not send a response, a check is made to see if there has been no response from the physical port for N consecutive iterations, the port management table 40 is looked up, the physical port status 43 entry for all the physical ports belonging to the same LAN line group number 42 of the port with no response is set to “Disable”, the LAN line connected to these physical ports is electronically shut off and forced to shutdown, and the current time is entered in the timestamps (step S79). This circuit multiplexer support process 70 is executed periodically by the CPU 30.

Next, an example in which the terminal 23 sends a packet (with a destination MAC address of “a”) will be described in detail. The circuit multiplexer 39 of the terminal 23 selects the LAN line 3 or the LAN line 4 for sending the packet. This selection can be performed using, for example, a round-robin method or the like. In this example, the LAN line 3 is selected for transmission. The packet sent by the terminal 23 is received by the information relaying apparatus 21. The relay processing module 32 of the information relaying apparatus 21 looks up the information relay table 50 and, since the destination MAC address 51 of the received packet is “a”, the received packet is relayed to the physical port number 52 entry “1”, i.e., the physical port 35. This relaying operation is a bridge relay operation using a LAN switch or the like. At this point, the information relaying apparatus 21 executes step S71, S76, and S77 of the circuit multiplexer support process 70. Since there are no failures, the port management table 40 is not updated.

The packet sent from the physical port 35 of the information relaying apparatus 21 is received by the information relaying apparatus 20 by way of the LAN line 1. The circuit multiplexer 39 of the information relaying apparatus 20 handles incoming packets as if they were received through a single LAN line regardless of whether they came from the LAN line 1 or the LAN line 2. The packet is then relayed to another LAN, e.g., the LAN line 5 shown in FIG. 1. Since the LAN lines 1, 2 are multiplexed by the circuit multiplexer 39 and used as a single logical LAN line, the packet received from the LAN line 1 does not get relayed to the LAN line 2. This completes the relaying of the packet sent from the terminal 23. If the circuit multiplexer 39 of the terminal 23 sends a packet to the LAN line 4, similar operations are performed by the information relaying apparatus 22 and the packet is relayed to the information relaying apparatus 20.

Next, an example of operations performed when a failure takes place in the LAN line 1, for example, will be described in detail. FIG. 5 shows the port management table 40 when a LAN line failure has occurred. If a failure takes place in the LAN line 1, a response to the ICMP Echo Request message is not received at step S77 of the circuit multiplexer support process 70 in the information relaying apparatus 21. Control then proceeds to step S78. A failure is not assumed and the port management table 40 is not updated until there has been no response N consecutive iterations at step S78. If there has been no response after N consecutive iterations, a failure condition is assumed and the port management table 40 is updated as shown in the figure at step S79. A failure condition is a condition wherein data communication does not occur.

In the port management table 40 shown in FIG. 5, the physical port status 43 entries are changed from the initial “Enable” state (as shown in FIG. 2) to “Disable” for all physical ports belonging to the same LAN line group number 42 of the physical port 35 (with physical port number “1”) connected to the LAN line 1, and the LAN lines for all physical ports, i.e., the LAN line 1 and the LAN line 3 are forced down Typically, this can be accomplished by removing power to the circuitry comprising the physical ports. Also, the current time (12:00:00 in this example) is entered for the timestamp. As a result, it appears to the circuit multiplexers 39 in the information relaying apparatus 20 and in the terminal 23 that a failure has taken place somewhere along LAN line 1 and LAN line 3.

As a result, the circuit multiplexers 39 of the information relaying apparatus 20 and the terminal 23 will subsequently send all packets using the LAN line 2 and the LAN line 4 in place of the LAN line 1 and the LAN line 3 at which the failure took place. This allows communication between the terminal 23 and the information relaying apparatus 20 to continue. The fault handling in the circuit multiplexers 39 can involve, for example, operations defined by the conventional Link Aggregation method, and does not require any non-standard or proprietary operations, and thus provides opportunity to reduce device and system costs. The circuit multiplexing method of this embodiment does not require any modifications to existing circuit multiplexers 39.

Next, an example of operations performed when there is recovery from a failure in the LAN line 1 will be described in detail. If at least T seconds have passed since a failure took place, step S71 and step S72 in the circuit multiplexer support process 70 of the information relaying apparatus 21 temporarily enables the LAN line 1 and the LAN line 3 and sends an ICMP Echo Request message. If the failure in the LAN line 1 has been recovered, all responses would be received. To allow all physical ports to receive responses, the port management table is updated again to the state shown in FIG. 2 at step S73 and step S74 of the circuit multiplexer support process 70. The physical port status of the physical ports connected to the LAN line 1 and the LAN line 3 are updated to “Enable” as FIG. 2 shows, thus allowing these physical ports to be used again.

As a result, the circuit multiplexers 39 of the information relaying apparatus 20 and the terminal 23 can again communicate with the LAN line 1 and the LAN line 3. If the LAN line 1 had not been recovered, responses would not be received from all physical ports at step S73 of the circuit multiplexer support process 70, so it would assume the line failure has not been recovered. At step S75, the timestamp 44 is updated and the operation is exited.

In the embodiment described above, the circuit multiplexer support process 70 uses ICMP Echo Request messages to check on LAN line status between adjacent devices. However, it would also be possible to use other methods such as ARP (Address Resolution Protocol) messages. Also, if Link Aggregation is implemented as the existing method in the circuit multiplexers 39, periodic LACP (Link Aggregation Control Protocol) control messages or the like can be monitored. In this case, the address table 60 would not be needed. These and other beacon techniques can be used.

Furthermore, it would also be possible for the information relaying apparatus 21 to monitor hardware-based error conditions as detected by the communication controller 34 and the physical port 35 itself. For example, if a PHY-LSI, MAC-LSI, or LAN link pulse failure or the like is detected, operations similar to those described above would be performed. This and other hardware-based techniques can be used.

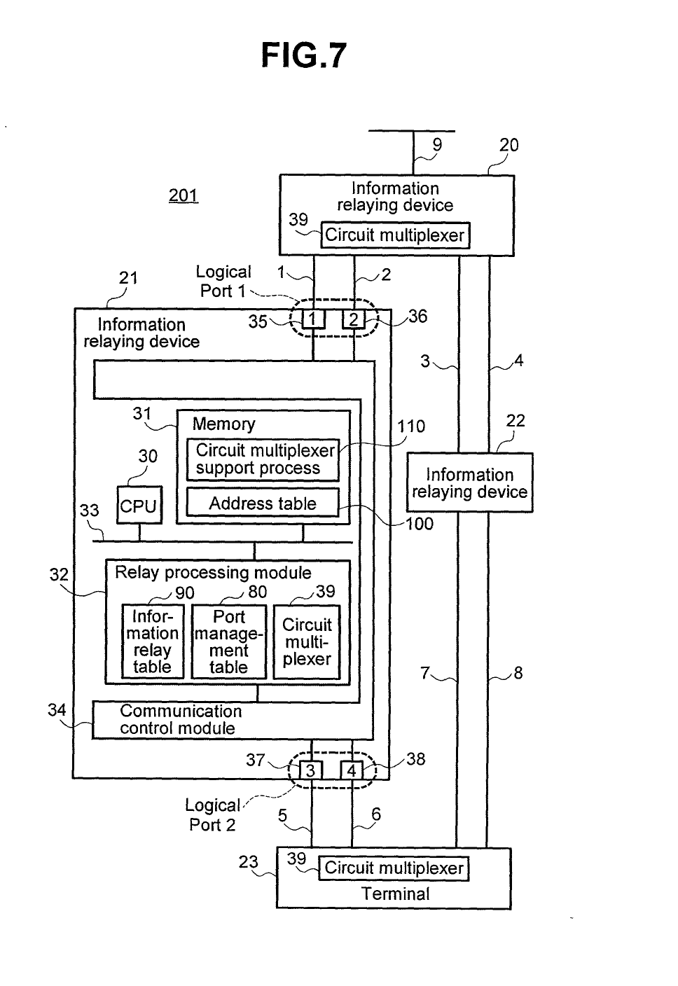

FIG. 7 is a schematic drawing of the architecture of an information network using the information relaying apparatuses 21, 22 according to a second embodiment of the present invention. While the information relaying apparatuses 21, 22 from the first embodiment do not use circuit multiplexing methods such as Link Aggregation, the information relaying apparatuses 21, 22 of this embodiment implement circuit multiplexing. Otherwise, the architectures are identical, so overlapping descriptions will be omitted.

The information relaying apparatus 21 in the information network 201 includes four physical ports (a physical port 35, a physical port 36, a physical port 37, and a physical port 38), which are connected to the LAN line 1, the LAN line 2, the LAN line 5, and the LAN line 6, respectively. The relay processing module 32 includes a circuit multiplexer 39. This circuit multiplexer 39 is identical to the circuit multiplexer 39 included in the terminal 23 and the information relaying apparatus 20. This circuit multiplexer 39 of each information relaying apparatus 21, 22 allows the terminal 23 and the information relaying apparatus 20 to be connected to the information relaying apparatuses 21, 22 through two LAN lines each (the LAN lines 1, 2, the LAN lines 3, 4, the LAN lines 5, 6, and the LAN lines 7, 8) using any conventional circuit multiplexing method such as Link Aggregation. The advantage is the multiplexing method need not be a proprietary one, and so system costs can be reduced. A further advantage is that the invention can be easily incorporated into existing data systems.

In this embodiment, the four LAN lines physically connecting the terminal 23 and the information relaying apparatus 20 by way of the information relaying apparatuses 21, 22 are handled as a single logical LAN line by the respective circuit multiplexers 39 in the terminal 23 and in the information relaying apparatus 20. While not shown in FIG. 7, the information relaying apparatus 22 has an architecture that is identical to that of the information relaying apparatus 21.

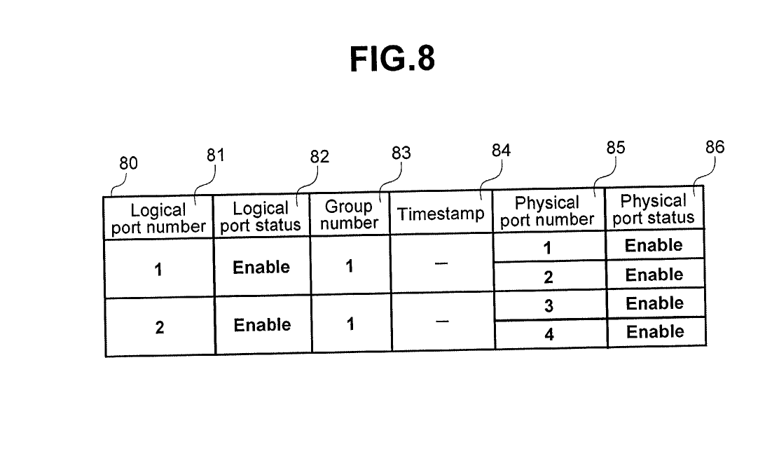

FIG. 8 shows the structure of a port management table 80. The port management table 80 includes: a physical port number 85 indicating the number of a physical port; a physical port status 86 indicating the status of the port; a logical port number 81 used to express a logical port containing multiple physical ports when multiple physical ports are combined by the circuit multiplexer 39; a logical port status 82 indicating the status of the logical port; a LAN line group number 83 identifying the LAN lines between the information relaying apparatus 20 and the terminal 23 to which the port is associated; and a timestamp 84 storing a failure time for a logical port if a failure takes place.

In this example, the physical port 35, the physical port 36, the physical port 37, and the physical port 38 are assigned entries of “1”, “2”, “3”, and “4” in the physical port number 85. The physical ports 35, 36 form a first group of ports and are identified by the logical port number 81 as logical port “1”. Similarly, the physical ports 37, 38 form a second group of ports and are identified by the logical port number 81 as logical port “2”. The LAN lines 1, 2 (associated with logical port number “1”) and the LAN lines 5, 6 (associated with logical port number “2”) are associated with each other by setting the LAN line group number 83 to “1”. Similarly, for the information relaying apparatus 22, the LAN lines 3, 4 and the LAN lines 7, 8 are associated with each other in the tables for information relaying apparatus 22.

In general, the logical ports comprise one or more ports related by the fact that they communicate with the same upstream or downstream apparatus. For example, FIG. 7 shows that logical port “1” comprises physical ports 35, 36 coupled to apparatus 20. Logical port “2” comprising physical ports 37, 38 are coupled to apparatus 23. In fact, the ports 35 and 36 shown in FIG. 1 can be viewed two sets of logical ports, each logical port comprising only one physical port.

The logical port status 82 and the physical port status 86 are set to “Enable” if the port is able to communicate and to “Disable” if the port is unable to communicate. Both the logical port status 82 and the physical port status 86 are set to “Enable” at initialization. The timestamp 84 is set up with no value at initialization.

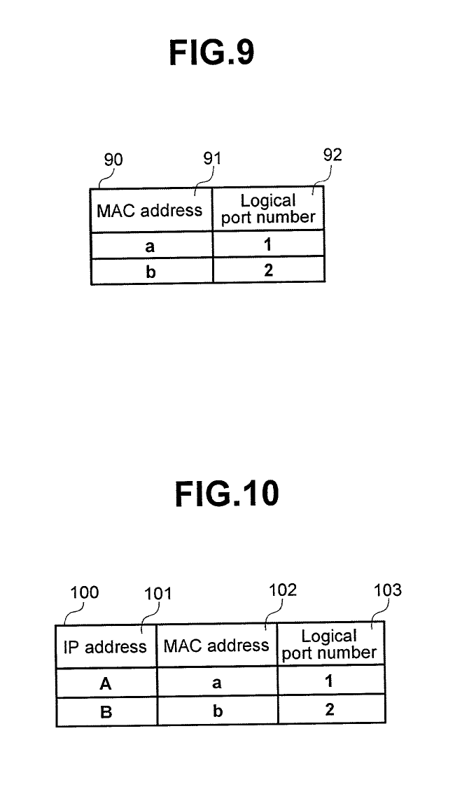

FIG. 9 shows the structure of the information relay table 90. The information relay table 90 includes: a MAC address 91; and a logical port number 92 of the port used to connect to the LAN line on which the apparatus with the MAC address 91 lies. The information relay table 90 is empty at initialization.

When a packet is received, the relay processing module 32 registers the MAC address contained in the packet header in the MAC address 91 and the port number from which the packet was received in the logical port number 92. In this case, the MAC address 91 entries for the information relaying apparatus 20 and the terminal 23 are set to “a” and “b” respectively. The logical port number 92 entries are set to logical port number “1” and logical port number “2” to indicate the LAN lines on which the information relaying apparatus 20 and the terminal 23 lie, respectively.

FIG. 10 shows the structure of an address table 100. The address table 100 includes: an IP address 101 of the terminal 23 or the adjacent information relaying apparatus 20; a MAC address 102; and a logical port number 103. In this case, the IP address 101 entries for the information relaying apparatus 20 and the terminal 23 are set to “A” and “B” respectively. The MAC address 102 entries are set to “a” and “b” respectively. The logical port number 103 entries are set to logical port number “1” and “2” to indicate the logical ports connecting to the LAN lines on which the information relaying apparatus 20 and the terminal 23 lie, respectively.

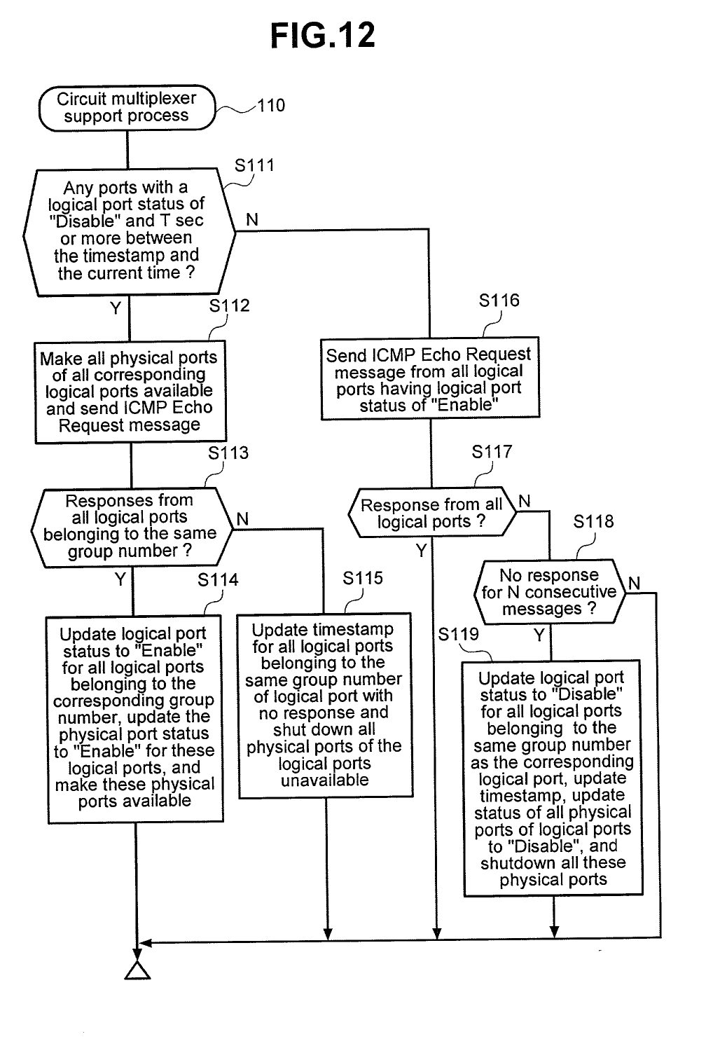

The following is an overview of the operations performed in this embodiment. FIG. 12 is a flowchart of a circuit multiplexer support process 110. First, the circuit multiplexer support process 110 looks up the port management table 80 and checks to see if there are any logical ports for which the logical port status 82 is “Disable” and for which at least T seconds have elapsed between the timestamp 84 and the current time (step S111). If there are any logical ports for which at least T seconds has elapsed, the LAN lines connected to the physical ports within these logical ports are temporarily recovered electronically to allow usage, and the address table 100 is looked up to send an ICMP Echo Request message (step S112). Next, responses to the message are monitored (step S113).

If responses (ICMP Echo Reply messages) are received for all logical ports within a single LAN line group number, it is assumed that failures in the logical ports within the LAN line group number have been recovered. The logical port status for these logical ports is updated to “Enable”, and the physical port status for the physical ports within the logical port is changed to “Enable”. The LAN lines connected to the physical ports are then electronically recovered to allow usage (step S114).

If responses were not received from all logical ports belonging to a single group number at step S113, the timestamps of the logical ports are reset with the current time, the LAN lines connected to these physical ports are electronically shut down, and the operation is exited (step S115). If there are no applicable logical ports at step S111, ICMP Echo Request messages are sent from all logical ports with logical port status “Enable” (step S116). Then, responses to these messages are monitored (step S117).

If responses (ICMP Echo Reply messages) are received from all logical ports, it is assumed that there are no failures, and the operation is exited. If any logical ports do not respond, a check is made to determine if the logical port has not responded for N consecutive iterations (step S118). If no response was received for N consecutive iterations, the port management table 80 is looked up and the logical port status 82 is updated to “Disable” for all logical ports belonging to the same LAN line group number 83 as this logical port. Then, the physical port status 86 for all physical ports within the logical ports are updated to “Disable”, and the LAN lines connected to these physical ports are electronically shut off and forced down. The timestamps are set to the current time, and the operation is exited (step S119). The circuit multiplexer support process 110 is executed periodically by the CPU 30.

Note that the failure condition is with respect to the “logical” port which comprises one or more physical ports. Thus, a logical port is not considered to be in a failed condition unless data communication is not possible via any of the physical ports comprising the logical port. If data communication is possible through at least one physical port, then there is no failed condition in the corresponding “logical” port.

Next, an example of operations performed when the terminal 23 sends a packet (destination MAC address “a”) will be described in detail. The circuit multiplexer 39 of the terminal 23 selects any of LAN lines 5 through 8 to send the packet. In this description, suppose the LAN line 5 is selected for packet transmission. The packet sent by the terminal 23 is received by the information relaying apparatus 21. The relay processing module 32 of the information relaying apparatus 21 looks up the information relay table 90 and, since the destination MAC address 91 of the received packet is “a”, the received packet is passed on to the circuit multiplexer 39 of information relaying apparatus 21 to be relayed to the logical port number 92 “1”. The circuit multiplexer 39 of information relaying apparatus 21 looks up the port management table 80 and selects one of the two physical port numbers 84 (either “1” or “2”) belonging to the logical port number 81 “1” to determine the physical port from which to actually send the packet, and sends the packet.

Next, the packet is received by the information relaying apparatus 20. Regardless of which of the four LAN lines (the LAN lines 1-4) the packet was received through, the circuit multiplexer 39 in the information relaying apparatus 20 handles the packet as if it were received from a single LAN line and relays the packet to another LAN line, e.g., the LAN line 9. In this way, the packet sent from the terminal 23 is relayed. In this operation, the information relaying apparatus 21 performs step S111, step S116, and step S117 of the circuit multiplexer support process 110. Since no failures or the like take place, the port management table 80 is not updated.

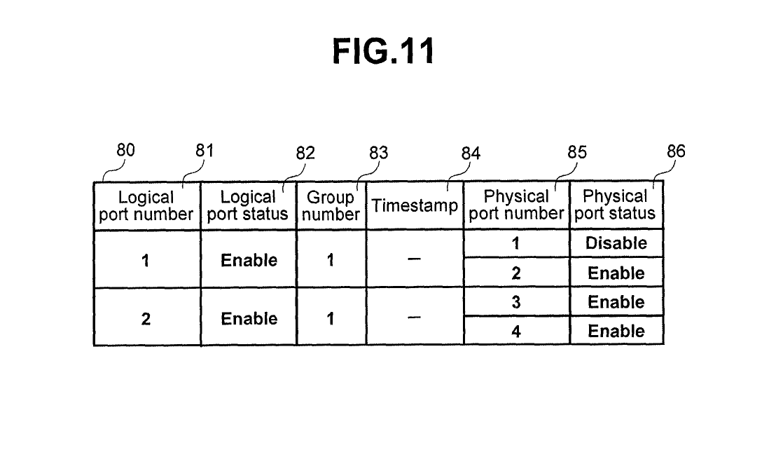

Next, an example of operations performed when a failure takes place in the LAN line 1 will be described in detail; however, LAN line 2 is still assumed to be able to support data communication. FIG. 11 shows the structure of the port management table 80 when a LAN line failure takes place. When a failure takes place in the LAN line 1, the circuit multiplexer 39 of the information relaying apparatus 21 detects the failure in the LAN line 1 connected to the physical port 35 (physical port number “1”). This failure detection by the circuit multiplexer 39 of information relaying apparatus 21 can be provided through LACP or the like if Link Aggregation is used. Alternatively, a hardware condition of the physical ports can be monitored, or the communication control module within the apparatus can be monitored. The circuit multiplexer 39 of information relaying apparatus 21 updates the port management table 80 so that the physical port status 86 corresponding to the physical port number 85 “1” is set to “Disable”.

Thus, if a packet is to be sent to the logical port number 81 “1”, the circuit multiplexer 39 of information relaying apparatus 21 uses only the physical port 36 having the physical port number 84 “2”. As a result, communication can be maintained between the terminal 23 and the information relaying apparatus 20. Note that the logical port “1” maintains a status of “Enable”, because physical port number “2” can still support communication in this example.

The fault handling in the circuit multiplexers 39 can involve, for example, operations defined by the conventional Link Aggregation method, and does not require any novel, non-standard, or proprietary operations. The circuit multiplexing method of this embodiment does not require any modifications to existing circuit multiplexers 39. This represents cost reducing opportunities and easy incorporation of the invention into existing data systems.

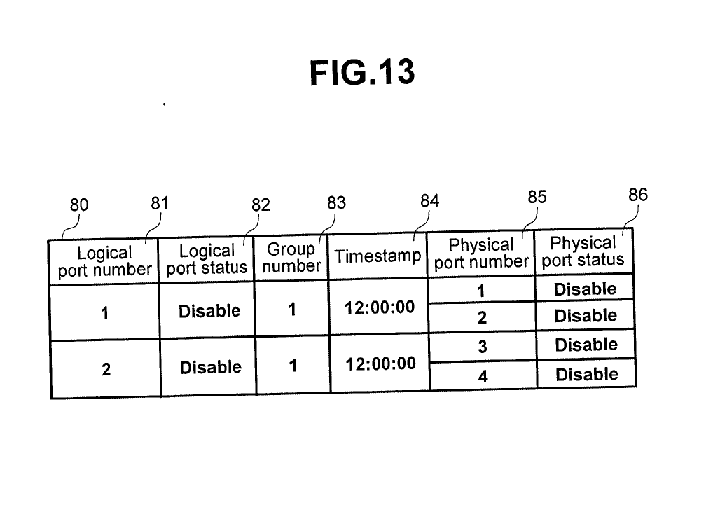

The following is a detailed description of an example of operations performed when a failure takes place in the LAN line 1, followed by a failure in the LAN line 2. FIG. 13 shows the structure of the port management table 80 when the LAN line failures (the LAN line 1 and 2) have taken place.

Since an ICMP Echo Request message from the information relaying apparatus 20 did not receive a response at step S116 of the circuit multiplexer support process 110, control proceeds to step S118. A failure is not assumed and the port management table 80 is not updated until step S118 determines that a response has not been received after N consecutive iterations. If no response is received for N consecutive iterations, a failure is determined to have taken place at the logical port number “1” and the port management table 80 in the information relaying apparatus 21 is updated as shown in the figure at step S119.

The logical port status 82 entry associated with the logical port number 81 “1” is updated to “Disable” in the port management table 80. The physical port status 86 for all physical ports belonging to the logical port number 81 are updated to “Disable”, and the LAN line connected to these physical ports are forced down. Also, the time stamp 84 entries are set to the current time (12:00:00 in this example). Furthermore, all logical port status 82 entries for the logical port number 81 entries belonging to the same group number 83 as the logical port number 81 “1” and all physical port status 86 entries of physical ports belonging to these logical ports are updated to “Disable” and the LAN lines connected to these physical ports are forced down. As a result, the circuit multiplexers 39 of the information relaying apparatus 20 and the terminal 23 are able to determine that a failure has taken place in the LAN lines 1, 2 and the LAN lines 5, 6, respectively.

Thus, the circuit multiplexers 39 of the information relaying apparatus 20 and the terminal 23 will send outgoing packets using only the LAN lines 3, 4 and the LAN lines 7, 8 instead of the LAN lines 1, 2, 5, and 6. This allows communication to continue between the terminal 23 and the information relaying apparatus 20.

Next, an example of operations performed on recovery from failures in the LAN line 1 and the LAN line 2 will be described in detail.

If, at step S111 and S112 of the circuit multiplexer support process 110 of the information relaying apparatus 21, at least T seconds have elapsed since the failures took place, the LAN line 1, the LAN line 2, the LAN line 5, and the LAN line 6 are temporarily put in a usable state and an ICMP Echo Request message is sent. If the failures at the LAN line 1 and the LAN line 2 have already been recovered, responses will be received from all logical ports having the group number 83 set to “1”. Since responses will be received from all logical ports, the port management table 80 will be updated to the state shown in FIG. 8 at step S113 and step S114 of the circuit multiplexer support process 110. As shown in FIG. 8, the logical port status of the logical ports connected to the LAN line 5 and the LAN line 6 are updated to “Enable” and the physical port statuses of the physical ports belonging to these logical ports are updated to “Enable”, thus allowing these physical ports to be usable again.

As a result, the circuit multiplexers 39 of the information relaying apparatus 20 and the terminal 23 are able to communicate using the LAN line 1, the LAN line 2, the LAN line 5, and the LAN line 6. If the LAN line 1 and the LAN line 2 are not recovered, responses will not be received from all logical ports at step S113 of the circuit multiplexer support process 110, and it will be assumed that the line failure has not been recovered. At step S115, the timestamp 84 entries are updated, and the operation is exited.

If a apparatus failure occurs in the information relaying apparatuses 21, 22 of this embodiment, the failure can be detected by implementing the circuit multiplexers 39 of the terminal 23 and the information relaying apparatus 20 with a protocol such as LACP in a Link Aggregation system. As a result, the circuit multiplexers 39 of the terminal 23 and the information relaying apparatus 20 will be able to avoid the LAN lines that are unusable and continue communications through the remaining LAN lines.

Next, a third embodiment, in which the information relaying apparatuses 21, 22 from the second embodiment are used in a different information network 202, will be described.

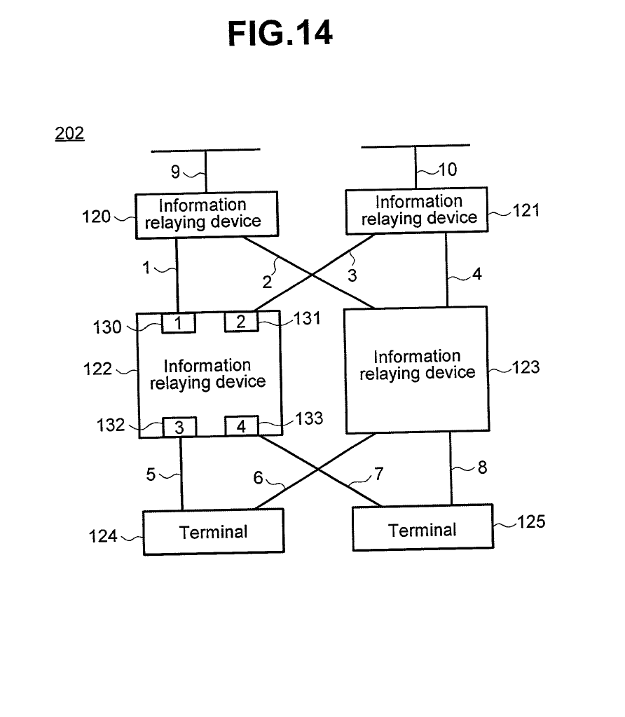

FIG. 14 is a schematic drawing of the architecture of a different information network 202 using information relaying apparatuses 122, 123 according to the third embodiment of the present invention. The different information network 202 can include, for example: information relaying apparatuses 120, 121 such as multi-layer switches implementing an existing circuit multiplexing method; and an information relaying apparatus 122 and an information relaying apparatus 123 such as a layer-two switch according to the second embodiment. The information relaying apparatus 122 and the information relaying apparatus 123 are disposed between two terminals (a terminal 124 and a terminal 125), e.g., servers. These elements are connected by LAN lines.

The information relaying apparatus 122 includes four physical ports 130-133 (with physical port numbers “1”-“4” respectively), and these are connected to a LAN line 1, a LAN line 3, a LAN line 5, and a LAN line 7. Data received in physical port 132 or physical port 133 can be transmitted from physical port 130 or physical port 131, depending on the routing information contained in the data. Conversely, data received in physical port 130 or physical port 131 can be transmitted from physical port 132 or physical port 133, depending on the routing information contained in the data. Similarly, the information relaying apparatus 123 includes four physical ports and is connected to four LAN lines.

FIG. 16 shows the structure of the port management table 40 of the information relaying apparatus 122. This port management table 40 provides associations for the LAN lines, e.g., the LAN lines between the information relaying apparatuses 120 and 121 and the terminals 124 125. The LAN line 1, the LAN line 3, the LAN line 5, and the LAN line 7 are set up with the common LAN line group number 42 “1”. As a result, if a failure takes place in the LAN line 1, the LAN line 3, the LAN line 5, or the LAN line 7, the LAN lines connected to the information relaying apparatus 123 can be used to allow communications to continue.

Next, a fourth embodiment, in which the information relaying apparatuses 21, 22 from the second embodiment are used in yet another information network 203, will be described.

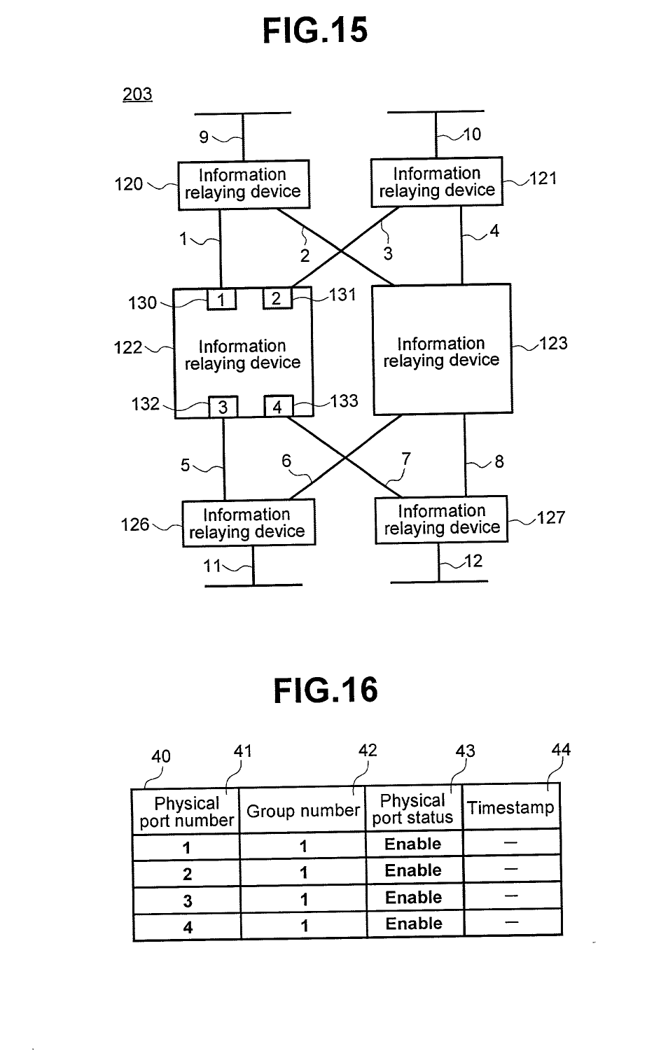

FIG. 15 shows a schematic drawing of the architecture of the information network 203 using the information relaying apparatuses 122, 123 according to the fourth embodiment of the present invention. In place of the terminals 124, 125 from the information network 202, the information network 203 uses information relaying apparatuses 126, 127, which use an existing circuit multiplexing method. The information network 203 provides similar advantages to those of the third embodiment described above.

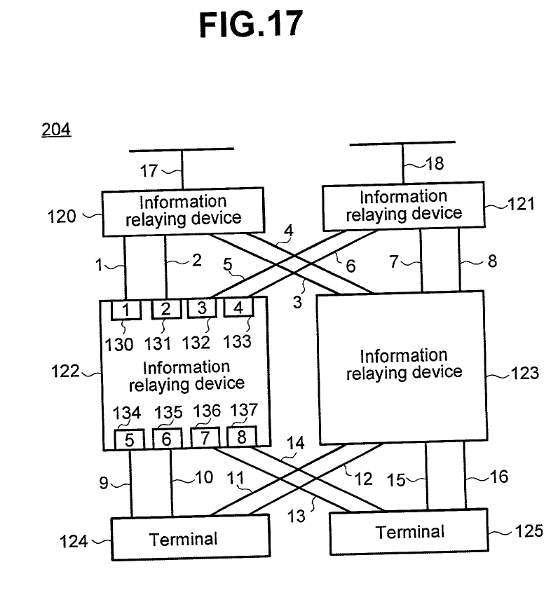

Next, a fifth embodiment, in which the information relaying apparatuses 21, 22 from the second embodiment are used in yet another information network 204, will be described. FIG. 17 shows a schematic drawing of the architecture of the information network 204 using the information relaying apparatuses 122, 123 according to the fifth embodiment of the present invention. This information network 204 includes the information relaying apparatus 122 and the information relaying apparatus 123 from the second embodiment, which are disposed between two terminals (a terminal 124 and a terminal 125) and the information relaying apparatus 120 and the information relaying apparatus 121, which use an existing circuit multiplexing method. Each of these are connected using two LAN lines.

The information relaying apparatus 122 includes eight physical ports 130-137 (with physical port numbers “1”-“8” respectively) and these are connected to a LAN line 1, a LAN line 2, a LAN line 5, a LAN line 6, a LAN line 9, a LAN line 10, a LAN line 13, and a LAN line 14, respectively. Here, ports 130 and 131 constitute a logical port, ports 132 and 133 constitute a logical port, ports 134 and 135 constitute a logical port, and ports 136 and 137 constitute a logical port. Data received in a first logical port (e.g. the logical port comprised of physical ports 134 and 135) or a second logical port (e.g. the logical port comprised of physical ports 136 and 137) can be transmitted from a third logical port (e.g. the logical port comprising physical ports 130 and 131) or a fourth logical port (e.g. the logical port comprising physical ports 132 and 133), depending on the routing information contained in the data. Similarly, the information relaying apparatus 123 also includes eight physical ports and is connected to eight LAN lines.

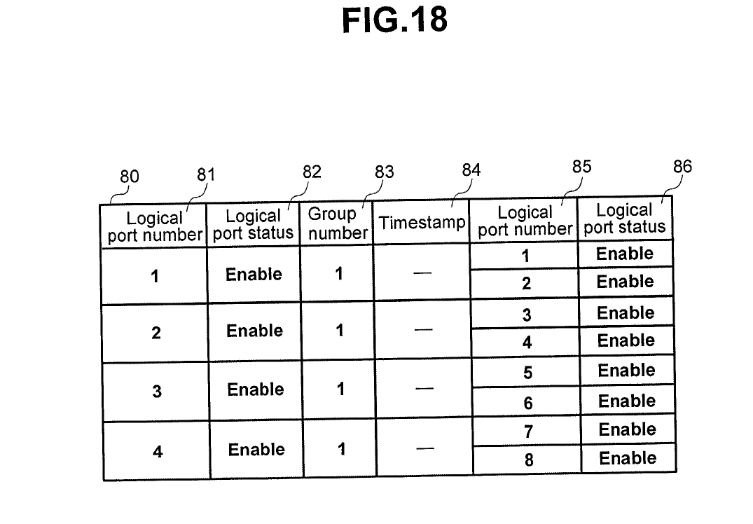

FIG. 18 shows the structure of the port management table 80 in the information relaying apparatus 122. In this example, the port management table 80 is set up with a single logical port number 81 for every two physical port numbers 85. If a failure takes place in the LAN line 1 (physical port number “1”), communication can continue using the LAN line 2. Also, if failures occur in both the LAN line 1 and the LAN line 2, the LAN lines on the information relaying apparatus 123 side can be used to continue communication.

With the embodiments described above, complete redundancy can be provided in an information network that includes multiple information relaying apparatuses and terminals. Also, the embodiments described above assume redundancy for information networks formed as Ethernet LANs and the like. In addition to LANs, however, the embodiments can also be used for other information networks such as WANs (Wide Area Networks) and SANs (Storage Area Networks).

Also, in the examples described for the information networks 200, 201, a single information relaying apparatus (information relaying apparatuses 21, 22) is placed in each of the two paths formed between the information relaying apparatus 20 and the terminal 23. However, similar advantages can be provided with multiple information relaying apparatuses arranged next to each other. This is useful in cases where a long distance is covered between the apparatuses (e.g., in WANs) and the like.

Furthermore, when the present invention is used for SANs, similar advantages can be provided by installing the information relaying apparatuses described above between terminals, e.g., servers, and between servers (terminals) and storage devices such as RAID Redundant Arrays of Inexpensive Disks devices. This improves the usability of lines between servers and RAID devices, thus improving the usability of the SAN system as a whole.

With the present invention as described above, the overall usability of a network system can be improved without making any changes in multiple devices equipped with existing circuit multiplexing technologies. Also, since the present invention does not require corrections or changes to devices equipped with existing circuit multiplexing technologies, the existing devices can be used directly, providing a low-cost, highly usable information network that is compatible with multi-vendor environments.

What is claimed is:

1. A data relay apparatus comprising:
a first group of one or more data ports;
a second group of one or more data ports; and
a controller configured to receive data from data ports of said first group and to transmit all of said data via data ports of said second group;
said controller configured to receive data from data ports of said second group and to transmit all of said data via data ports of said first group;
said controller configured to disable all data ports of said second group in response to detecting that data communication is not available via any data port of said first group,
said controller configured to disable all data ports in said first group in response to detecting that data communication is not available via any data port in said second group.

2. The data relay apparatus of claim 1 wherein said controller is further configured to enable all data ports of said first and second groups when all of said data ports have been disabled for a first period of time, to determine if communication is available via any data port of said first group or via any data port of said second group, and to disable all of said data ports if it is determined that said communication is not available.

3. The data relay apparatus of claim 1 wherein said controller is further configured to send test data through data ports of said first group and of said second group to detect whether data communication is available via said data ports.

4. The data relay apparatus of claim 3 wherein said test data include ICMP (internet control management protocol) ECHO requests, or ARP (address resolution protocol) messages, or LACP (link aggregation control protocol) control messages.

5. The data relay apparatus of claim 1 wherein said controller is further configured to monitor data ports of said first group and of said second group for hardware error conditions in said data ports to detect whether data communication is available via said data ports.

6. The data relay apparatus of claim 1 as incorporated in a data relay system, said data relay system comprising at least a first one of said data relay apparatus, a second one of said data relay apparatus, and a third one of said data relay apparatus,
data ports of said first group in said first data relay apparatus being configured for data communication with a data terminal,
data ports of said first group in said second data relay apparatus being configured for data communication with said data terminal,
data ports of said second group in said first data relay apparatus being in data communication with data ports of said first group in said third data relay apparatus,
data ports of said second group in said second data relay apparatus being in data communication with data ports of said first group in said third data relay apparatus,
wherein data transmission between said data terminal and said third data relay apparatus occurs via said first data relay apparatus or via said second data relay apparatus.

7. The data relay apparatus of claim 1 further including at least a third group of one or more data ports and a fourth group of one or more data ports,
said controller further configured to transmit all first data received from data ports of said first and third groups to data ports of said second group or to data ports of said fourth group based on information contained in said first data,
said controller further configured to transmit all second data received from data ports of said second and fourth groups to data ports of said first group or to data ports of said third group based on information contained in said second data,
said controller further configured to disable all data ports of said first, second, third, and fourth groups in response to detecting that data communication is not available via any data port of said first group and via any data port of said third group,
said controller further configured to disable all data ports of said first, second, third, and fourth groups in response to detecting that data communication is not available via any data port of said second group and via any data port of said fourth group.

8. The data relay apparatus of claim 7 as incorporated in a data relay system comprising at least a first one of said data relay apparatus, a second one of said data relay apparatus, a third one of said data relay apparatus, and a fourth one of said data relay apparatus,
data ports of said second group in said first data relay apparatus being in data communication with data ports of said first group in said third data relay apparatus,
data ports of said fourth group in said first data relay apparatus being in data communication with data ports of said first group in said fourth data relay apparatus,
data ports of said second group in said second data relay apparatus being in data communication with data ports of said third group in said third data relay apparatus,
data ports of said fourth group in said second data relay apparatus being in data communication with data ports of said third group in said fourth data relay apparatus.

9. A data relay apparatus comprising:
a first plurality of data ports;
a second plurality of data ports; and
a controller configured to receive first data from said first data ports and to transmit all of said first data via one or more of said second ports, said controller further configured to receive second data from said second ports and to transmit all of said second data via one or more of said first ports;
said controller further configured to determine if communication is not possible via any of said first data ports by transmitting test data via said first data ports and if communication is not possible via any of said first data ports to disable all of said first and second data ports,
said controller further configured to determine if communication is not possible via any of said second data ports by transmitting test data via said second data ports and if communication is not possible via any of said second data ports to disable all of said first and second data ports.

10. The data relay apparatus of claim 9 wherein said controller is further configured:
to re-enable all of said first and second data ports after a first period of time;
to re-determine if communication is possible via any of said first data ports and via any of said second data ports; and
if not to disable all of said first and second data ports.

11. The data relay apparatus of claim 9 wherein said test data include ICMP (internet control management protocol) ECHO requests, or ARP (address resolution protocol) messages, or LACP (link aggregation control protocol) control messages.

12. In a data relay apparatus having a plurality of data ports, a method for relaying data comprising:
receiving first data from a first group comprising one or more of said data ports;
receiving second data from a second group comprising one or more of said data ports;
transmitting all of said first data via data ports of said second group;
transmitting all of said second data via data ports of said first group; and
determining whether transmission of data is not successful via any of said data ports of said first group or via any of said data ports of said second group and if so disabling all data ports of said first and second groups.

13. The method of claim 12 further including, subsequent to said disabling, enabling all data ports of said first and second groups, determining whether transmission of data is not successful via any of said data ports of said first group or via any of said data ports of said second group, and, if so, disabling all data ports of said first and second groups.

14. The method of claim 12 wherein said determining includes transmitting first test data through data ports of said first group and transmitting second test data through data ports of said second group.

15. The method of claim 14 wherein said first and second test data include ICMP (internet control management protocol) ECHO requests, or ARP (address resolution protocol) messages, or LACP (link aggregation control protocol) control messages.

16. The method of claim 12 wherein said determining includes detecting error conditions in circuitry comprising data ports of said first group and said second group.

17. The method of claim 12 wherein a first one of said data relay apparatus, a second one of said data relay apparatus, and a third one of said data relay apparatus is incorporated in a data switching system, said method further including:
transferring third data between a data source and data ports of said first group in said first and second data relay apparatuses;
transferring said third data between data ports of said second group in said first and second data relay apparatuses and data ports in said third data relay apparatus,
wherein data transfer between said data source and said third data relay apparatus can occur via said first data relay apparatus or via said second data relay apparatus.

18. The method of claim 12 further including:
receiving third data from a third group comprising one or more of said data ports;
receiving fourth data from a fourth group comprising one or more of said data ports;
transmitting all of said first data via data ports of said second group or via data ports of said fourth group, depending on information contained in said first data;
transmitting all of said second data via data ports of said first group or via data ports of said third group, depending on information contained in said second data;
transmitting all of said third data via data ports of said second group or via data ports of said fourth group, depending on information contained in said third data;
transmitting all of said fourth data via data ports of said first group or via data ports of said third group, depending on information contained in said fourth data;
determining whether transmission of data is not successful via any of said data ports of said first and third groups and if so disabling data ports of said first, second, third, and fourth groups; and
determining whether transmission of data is not successful via any of said data ports of said second and fourth groups and if so disabling data ports of said first, second, third, and fourth groups.

19. The method of claim 18 wherein a first one of said data relay apparatus, a second one of said data relay apparatus, a third one of said data relay apparatus, and a fourth one of said data relay apparatus are incorporated in a data switching system, said method further comprising:
transferring fifth data between a first data source and data ports of said first group in said first data relay apparatus;
transferring said fifth data between data ports of said second and fourth groups in said first data relay apparatus and data ports in said third and fourth data relay apparatuses;
transferring sixth data between said first data source and data ports of said first group in said second data relay apparatus;
transferring said sixth data between data ports of said second and fourth groups in said second data relay apparatus and data ports in said third and fourth data relay apparatuses;
wherein data transfers between said first data source and said third and fourth data relay apparatuses can occur via said first data relay apparatus or via said second data relay apparatus.

20. The method of claim 19 further comprising:
transferring seventh data between a second data source and data ports of said third group in said first data relay apparatus;
transferring said seventh data between data ports of said second and fourth groups in said first data relay apparatus and data ports in said third and fourth data relay apparatuses;
transferring eighth data between said second data source and data ports of said third group in said second data relay apparatus;
transferring said sixth data between data ports of said second and fourth groups in said second data relay apparatus and data ports in said third and fourth data relay apparatuses;
wherein data transfers between said second data source and said third and fourth data relay apparatuses can occur via said first data relay apparatus or via said second data relay apparatus.

21. A data relay apparatus comprising:
a first group of one or more data ports;
a second group of one or more data ports;
means for relaying all data received by data ports in one of said first and second groups to data ports in the other of said first and second groups;
means for detecting when all data ports of said first group or all data ports of said second group are incapable of successful data transmission; and
means, in response to said means for detecting, for disabling all data ports of said first and second groups.

22. The apparatus of claim 21 further including means for restoring said data ports after said data ports have been disabled for a first period of time for detecting again if all data ports of said first group or all data ports of said second group are incapable of successful data transmission and in response thereto disabling all data ports of said first and second groups.

23. The apparatus of claim 21 wherein said means for detecting includes means for transmitting test data through said data ports.

24. The apparatus of claim 23 wherein said test data includes ICMP (internet control management protocol) ECHO requests, or ARP (address resolution protocol) messages, or LACP (link aggregation control protocol) control messages.

25. The apparatus of claim 21 wherein said means for detecting includes means for detecting error conditions in the circuitry comprising said data ports.

26. A data relay system comprising:
a first data relay apparatus;
a second data relay apparatus;
a third data relay apparatus; and
at least a fourth data relay apparatus,
each of said relay apparatuses comprising:
a plurality of first data ports;
a plurality of second data ports; and
a controller configured to receive data from one of said first data ports and to transmit said data via one of said second data ports, based on information contained in said data;
said controller configured to disable all of said second data ports in response to detecting that data communication is not available via any of said first data ports,
said controller configured to disable all of said first data ports in response to detecting that data communication is not available via any of said second data ports,
said second data ports of said first data relay apparatus, each configured for data communication with one of said first data ports of either said third data relay apparatus or said fourth data relay apparatus,
said second data ports of said second data relay apparatus, each configured for data communication with one of said first data ports of either said third data relay apparatus or said fourth data relay apparatus.

27. The system of claim 26 further including a first data terminal and a second data terminal, each of said data terminals configured to send data to said first data ports of said first and second data relay apparatuses, wherein each of said data terminals can communicate with said third and fourth data relay apparatuses via said first data relay apparatus or via said second data relay apparatus.
